(19) United States
(12) Patent Application Publication
(10) Pub. No.: US 2004/0010971 A1
(43) Pub. Date: Jan. 22, 2004

(54) Grow pole

(76) Inventors: Karen E. Redfield, Pensacola, FL (US); Isaac I. Thornton, Everett, WA (US)

Correspondence Address: Richard C. Litman, LITMAN LAW OFFICES, LTD., P.O. Box 15035, Arlington, VA, 22215, US

(21) Appl. No.: 10/607,266

(22) Filed: Jun. 27, 2003

Related U.S. Application Data
(60) Provisional application No. 60/392,967, filed on Jul. 2, 2002.

(51) Int. Cl. A01G 9/02

(52) U.S. Cl. 47/83; 47/65.5

(57) ABSTRACT

The grow pole is a hollow tube for growing multiple plants. The tube has vertical portals into which plants and their supporting medium are inserted. The tube has an end cap on its bottom end for supporting growth media disposed in the tube. Thus, the tube is at least partially filled with plant growing medium, such as dirt, and supporting structure or material to hold multiple plants and to permit watering through one end of the tube. If desired, a plant may be inserted in one end of the tube. Along its length, the tube includes multiple ventilation holes to provide oxygen to the roots.

### CROSS-REFERENCE TO RELATED APPLICATION

This application claims the benefit of U.S. Provisional Patent Application Serial No. 60/392,967, filed Jul. 2, 2002.

### BACKGROUND OF THE INVENTION

1. Field of the Invention

The present invention relates to a multi-plant container, and particularly to a hollow tube with vertical portals. Plants are inserted in the portals and also the top end, if desired. The tube, in a single or multiple arrangement, may be supported or suspended in a generally vertical alignment, and thus need not rest on the ground.

2. DESCRIPTION OF RELATED ART

For centuries, people have potted plants in order to be able to enjoy greenery indoors and in other soil less environments, such as patios and concrete-covered outdoor areas.

Round flowerpots are very common containers. However, they generally hold only one plant. Rectangular boxes are a common way to hold multiple plants in one container. Generally, these boxes rest on the ground or are attached to windowsills or railings. Unfortunately, this type of container requires a large amount of horizontal space. Horizontal space is often scarce, particularly for city dwellers and office workers or in classrooms. To reduce the amount of horizontal space used by multiple plants, designers developed tiered shelves that can accommodate several pots. Unfortunately, tiered shelves are cumbersome and make watering multiple plants difficult. Additionally, they require floor space. Hanging pots are available, but due to their size and shape, they are not appropriate for multiple plants.

Even where horizontal space is available, there are obstacles to vertical growth. For plants to grow vertically, the planters must include some sort of support pole or stake. Besides the additional expense, difficulties can arise trying to keep the support pole from tipping due to the weight of the plants.

Furthermore, the dirt in these horizontal planters is exposed, and thus vulnerable to infestation by soil living pests and to dehydration. Various improvements have been proposed to alleviate these problems.

U.S. Pat. No. 6,094,861, issued on Aug. 1, 2000 to A. Sandman, describes a hanging container for growing tomatoes and other vegetables. The device is essentially a hanging bucket with a hole in the bottom through which a tomato vine or other vegetable plant descends. This container cannot hold more than one plant.

U.S. Pat. No. 4,942,692, issued on Jul. 24, 1990 to M. T. Colbert, describes a live plant wreath that can be hung on a wall. The wreath is made from a wire frame filled with soil and wrapped in a mat of sphagnum moss. The device can accommodate multiple plants, but is difficult to assemble and the moss wrapping can deteriorate.

U.S. Pat. No. 5,598,662, issued on Feb. 4, 1997 to D. A. Droste, describes a multi-tiered plant stand and fountain.

The stand includes a center pole that extends from ceiling to floor. While the stand occupies very little horizontal space, it necessitates the use of multiple pots. Multiple pots entail more expense and more time spent watering pots.

U.S. Pat. No. 2,079,116, issued on Mar. 4, 1936 to C. E. Gardner, describes a semi-potted plant package composed of an open-ended cylinder made of paperboard. The plant protrudes through the top. However, like other single pots, the '116 device only holds one plant.

U.S. Pat. No. 3,362,106, issued on Jan. 9, 1968 to J. E. Goldring, shows a seed package with periodically spaced holes through which seedlings emerge. The seed package is an elongated tube filled with plant life support material. Goldring's device is intended to be placed on the ground, thus imitating conventional crop growing, rather than hung in a novel vertically stacked fashion.

Patents that show poles and other support for vertical plant growth include German Patent No. 3,622,741, published on Jan. 7, 1988 (a PVC pipe that can be covered with sheeting in order to act as scaffolding for plants); United Kingdom Patent No. 2,233,200, published on Jan. 9, 1991 (metal mesh welded to supporting poles inserted in the ground); Japanese Patent No. 9-28202, published on Feb. 4, 1997 (a vertical pipe attached to a supporting plate in the bottom of a pot).

U.S. Pat. No. 6,247,269, issued on Jun. 19, 2001 to M. A. Valiquette, shows multiple planters attached to a deck railing. The planters are arranged vertically in columns of 2. While this arrangement provides for additional use of vertical space, multiple containers are required and only 2 plants occupy the same vertical column.

U.S. Pat. No. 5,456,555, issued on Oct. 10, 1995 to H. Bokeler, describes building blocks with recesses to hold dirt for growing plants. These blocks provide greenery in urban-concreted areas as well as on the side of buildings. However, because these blocks are incorporated during building construction, retrofitting them into an existing building would be complicated and expensive. An additional disadvantage is the high maintenance due to many individual areas of plant growth.

None of the above inventions and patents, taken either singly or in combination, is seen to describe the instant invention as claimed.

### SUMMARY OF THE INVENTION

The grow pole is a hollow tube for growing multiple plants. The tube has vertical portals into which plants and their supporting medium are inserted. The grow pole has an end cap at its bottom end to retain plant media therein. Thus, the tube is at least partially filled with plant growing medium, such as dirt, and supporting structure or material to hold multiple plants and to permit watering through one end of the tube. If desired, a plant may be inserted in one end of the tube. Along its length, the tube includes multiple ventilation holes to provide oxygen to the plant roots. The tube, in a single or multiple arrangement, is supported or suspended in a generally vertical alignment, and thus need not necessarily rest on the ground.

Accordingly, it is a principal object of the invention to hold multiple plants in a single container in order to make maximum use of limited space.

It is another object of the invention to lift plants off the ground.

Yet another object of the invention is to simplify the care and watering of multiple plants.

It is a further object of the invention to provide a vertical arrangement of plant growth for decks and patios.

Still another object of the invention is to provide large areas of plants on interior or exterior walls of buildings.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a grow pole according to the present invention showing multiple plants emerging from multiple portals.

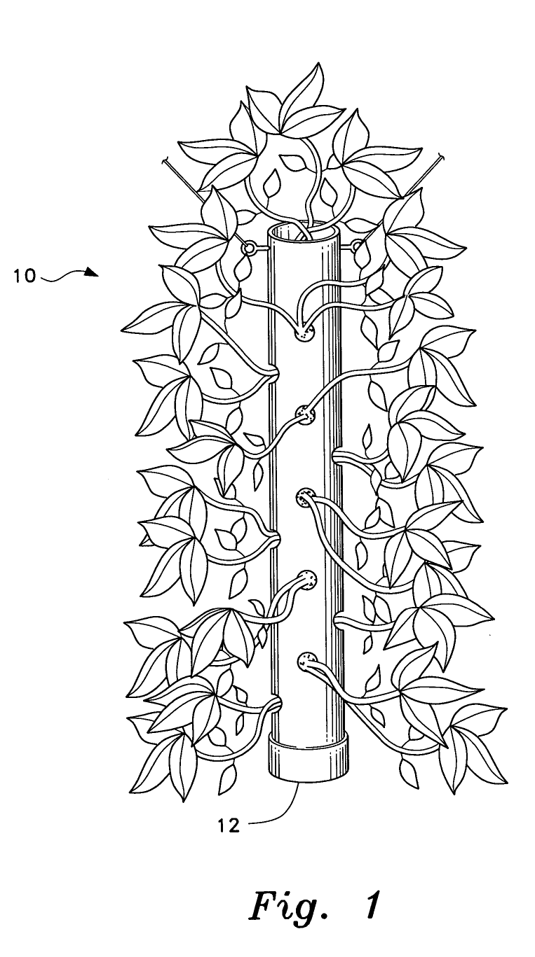

FIG. 2 is a front view of a grow pole according to the present invention showing the preferred pattern of plant portals.

FIG. 3 is a rear view of a grow pole according to the present invention showing the preferred pattern of ventilation holes.

FIG. 4 is a vertical cross-sectional view of a grow pole according to the present invention.

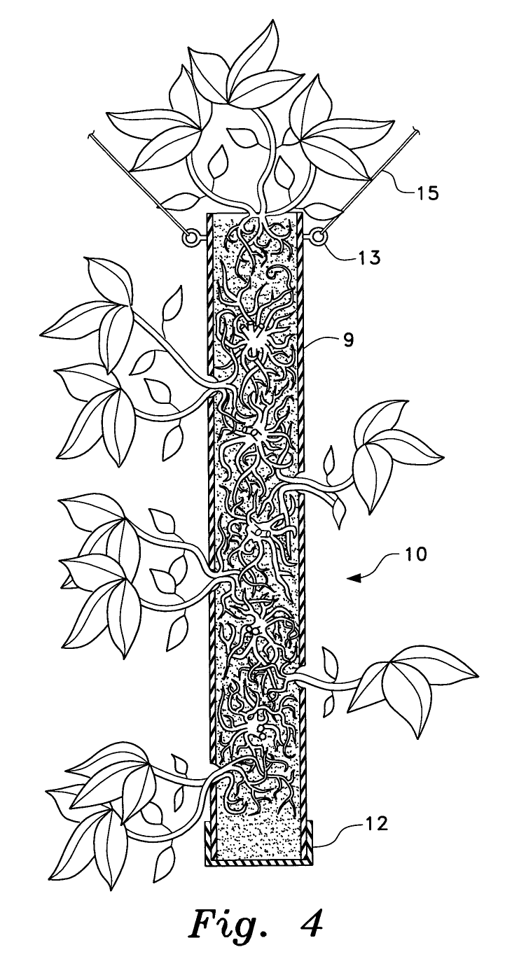

Similar reference characters denote corresponding features consistently throughout the attached drawings.

### DETAILED DESCRIPTION OF THE PREFERRED EMBODIMENTS

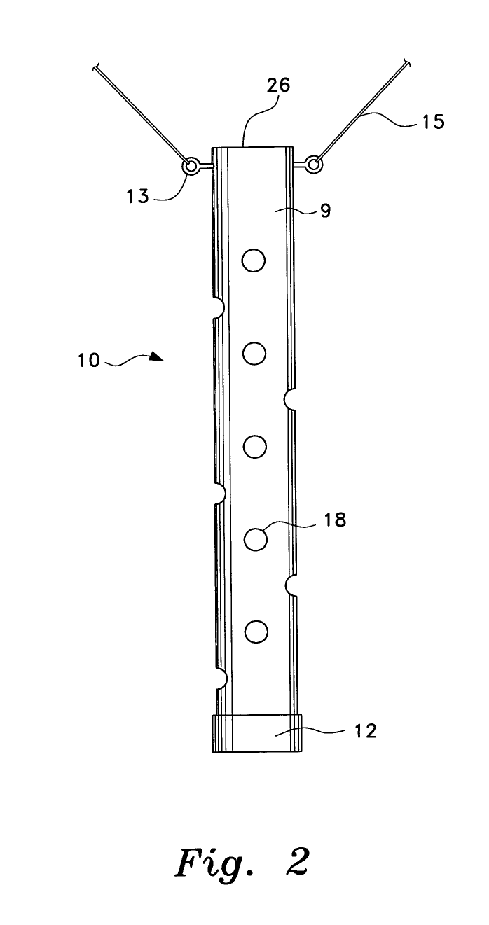

The grow pole 10 is a plant container designed to hold multiple plants above the ground. Referring first to FIG. 2, the invention is a tube 9 with evenly spaced portals 18 down its front. Additional portals are located in an alternating pattern down either side of the tube 9. The top end 26 is open. The bottom end is covered with a push on end cap 12. The tube 9 is suspended from a ceiling or other support by means of eyebolts 13 and cable 15. Eyebolts 13 can be received in opposing apertures in the top end 26 of the tube 9, or a vinyl-coated wire can be threaded through the apertures in the top end 26 and crimped at both ends to form a loop to suspend the grow pole 10 from a wall or post.

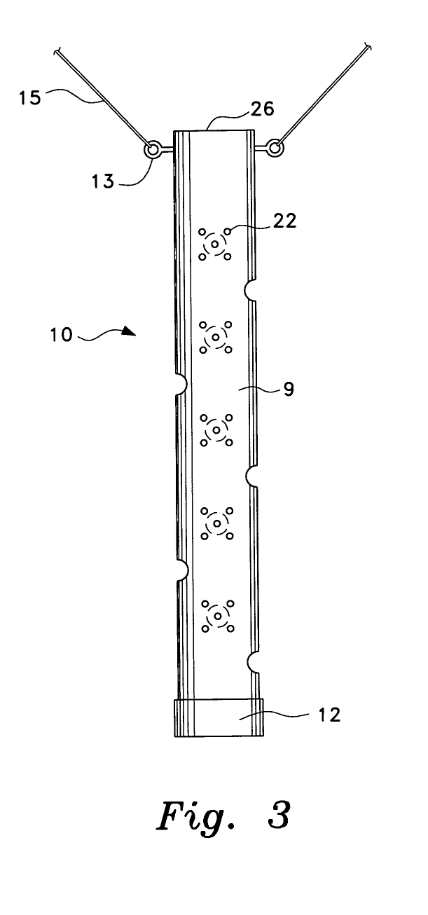

Referring next to FIG. 3, the invention includes evenly spaced groups of five ventilation holes 22 down the back of the tube 9. The ventilation holes 22 are spaced apart along the length of the pole 10 and provide means for aeration of the roots of plants adjacent the ventilation holes.

To use the invention, plant-growing material is poured through the top opening 26 of the tube 9 while plants are inserted into the portals 18. Plants should be inserted starting from the bottom portal 18 and continuing up the tube 9 as the plant growing material gradually fills the tube 9. A preferred plant-growing material is the well-known product, Miracle Grow®.

An exemplary method of making the invention will now be described by way of enablement, and not by way of limitation. A 4″ diameter polyvinyl chloride (PVC) pipe is cut to a 5′ length with 2″ diameter portals 18 drilled in the spiral pattern shown in FIG. 2. One-quarter inch diameter ventilation holes 22 are drilled in the pattern shown in FIG. 3, directly opposite corresponding front portals 18. The tube 9 and end cap 12 are sanded and spray-painted in various colors. Two eyebolts 13 are screwed in the top on opposite sides of the tube 9 using leftover portal cutouts as washers. The tube 9 and end cap 12 may be made from any other rigid, water impermeable, lightweight, thermoplastic material.

Alternatively, the invention may be fashioned in a miniature embodiment where a 1.5″ diameter pipe is cut to 2.5′ lengths and provided with ¾-1″ diameter portals. It has been found that the miniature embodiment of the invention functions satisfactory without the addition of ventilation holes.

The tube 9 may be formed from pipes of any diameter cut to any desired length, as long as the ratio of pipe diameter and portal diameter is approximately 2:1.

Alternatively, eyebolts may be added to the back of the tube 9 in order to suspend the invention from hooks attached to the side of a deck railing. This type of support permits tubes to be arranged across an entire wall, thus forming a Grow Wall.

It is to be understood that the present invention is not limited to the sole embodiments described above, but encompasses any and all embodiments within the scope of the following claims.

We claim:

1. A grow pole for containing plants, comprising:
an elongated tube having a top end and a bottom end, said tube having a plurality of portals defined therein, each portal being sized and dimensioned for receiving a plant; and
an end cap disposed on the bottom end of said tube.

2. The grow pole according to claim 1, wherein said tube has a plurality of ventilation holes defined therein spaced apart longitudinally.

3. The grow pole according to claim 1, further comprising means for suspending said pole from a support.

4. The grow pole according to claim 3, wherein said means for suspending said pole from a support comprises a pair of eyebolts attached to the top end of said tube.

5. The grow pole according to claim 3, wherein said means for suspending said pole from a support comprises an eyebolt attached to the back of the top end of said tube for suspending said pole from hooks.

6. The grow pole according to claim 4, further including an additional eyebolt attached to the back of said tube for suspending said pole from hooks.

7. A grow pole for containing plants, comprising:
an elongated tube having a top end and a bottom end, said tube having a plurality of portals arranged in a spiral defined therein, each portal being sized and dimensioned for receiving a plant; and
a pair of opposed apertures in the top end of said tube for suspending said pole from a support.

8. The grow pole according to claim 7, further including a pair of eyebolts received in said opposed apertures in the top end of said tube.

9. The grow pole according to claim 8, further including an additional eyebolt secured in an aperture in the back of said tube at said top end for suspending said pole from hooks.

10. A method of forming a grow pole comprising the steps of:
cutting polyvinyl chloride (PVC) pipe into a tube of a desired length, having a top end and a bottom end;
drilling portals of approximately one half the diameter of said tube into said tube in a spiral pattern;
providing an end cap on the bottom end of said tube; and
providing means on said tube for suspending said pole from a support.

11. The method according to claim 10, wherein the step of providing means for suspending said pole from a support comprises providing holes at the top end of said tube for receiving one of a pair of eyebolts and a vinyl-coated wire crimped on each end.

12. The method according to claim 10, further including the step of providing an additional eyebolt attached to the back of said tube for suspending said pole from hooks.

13. The method according to claim 12, further including the step of sanding and spray-painting said tube and end cap.

14. The method according to claim 10, further including the step of drilling ¼″ diameter ventilation holes directly opposite portals in the front of said tube.

15. The method according to claim 14, further including the step of sanding and spray-painting said tube and end cap.

16. The method according to claim 15, wherein said tube is four inches in diameter and said desired length is five feet.

17. The method according to claim 15, wherein said tube is one to two inches in diameter and said desired length is two and one half feet.

18. The method according to claim 15, wherein said tube is four inches in diameter and said desired length is ten feet.

19. The method according to claim 16, further including the step of drilling a plurality of ventilation holes in the back of said tube directly opposite corresponding portals in the front of said tube.

20. The method according to claim 18, further including the step of drilling a plurality of ventilation holes in the back of said tube directly opposite corresponding portals in the front of said tube.
